(19) United States
(12) Patent Application Publication
(10) Pub. No.: US 2017/0255585 A1
(43) Pub. Date: Sep. 7, 2017

(54) METHOD AND SYSTEM FOR SWITCHING ROLE OF USB OTG DEVICE AND OTG DEVICE THEREOF

(71) Applicant: MediaTek Singapore Pte. Ltd., Singapore (SG)

(72) Inventors: Jingbo ZHANG, Hefei City (CN); Chengchun NI, Hefei City (CN)

(21) Appl. No.: 15/438,850

(22) Filed: Feb. 22, 2017

(30) Foreign Application Priority Data
Mar. 1, 2016 (CN) 201610116817.4

(51) Int. Cl. G06F 13/40; G06F 13/38; G06F 13/42

(52) U.S. Cl. CPC G06F 13/4022; G06F 13/4286; G06F 13/385

(57) ABSTRACT

A method and system of switching a role of a Universal Serial Bus (USB) On-The-Go (OTG) device and a USB OTG device are provided. According to the method, when the USB OTG device receives a Host Negotiation Protocol (HNP) request sent from a link-partner, an OTG controller of the USB OTG device is reset. The state of an ID-pin detection end which is used by the OTG controller to detect a type of plug of a USB cable is modified to switch the role of the USB OTG device between a host and a peripheral.

### CROSS REFERENCE TO RELATED APPLICATIONS

This application claims priority of China Patent Application No. 201610116817.4, filed on Mar. 1, 2016, the entirety of which is incorporated by reference herein.

### BACKGROUND OF THE INVENTION

Field of the Invention

The invention relates to a method and system for switching the role of a Universal Serial Bus (USB) On-The-Go (OTG) device and a USB OTG device.

Description of the Related Art

A Universal Serial Bus (USB) is a universal interface for data interchange and has been widely used in various communication products. As the computing capacity of mobile devices has enhanced and the requirements of practical applications, the Universal Serial Bus Implementer Forums (USB IF) created the standard for USB OTG devices.

The USB OTG standard is a supplement to the USB 2.0 standard. An OTG product is a portable device which uses a single dual-role receptacle (Mini-AB receptacle or Micro-AB receptacle). When two devices which support the OTG standard connect with each other, through the plugs (A-plug and B-plug) at the two ends of the USB connection line, a default host (A-device: the device which supports the OTG standard and is coupled to the A-plug) and a default peripheral (A-device: the device which supports the OTG standard and is coupled to the B-plug) can be identified. Specifically, a device with the USB OTG function has added a fifth pin ID for identifying different roles of a USB OTG. When a USB OTG device detects that the pin ID is coupled to the ground (low voltage level), the link-partner which communicates with the USB OTG device is identified as a USB peripheral, and the USB OTG device is set as a USB host. When the USB OTG device detects that the pin ID is floating (high voltage level), the link-partner is coupled to the USB OTG device is identified as a USB host, and the USB OTG device is set as a USB peripheral.

Moreover, for the A-device and the B-device, the role switching between a host and a peripheral can be implemented through the Host Negotiation Protocol (HNP). The OTG protocol allows a lower-level driving element to switch between a USB host role and a peripheral role without changing the physical position of the electric cable. Thus, there are four states for a USB OTG device with the HNP function: A-host. A-peripheral. B-host, and B-peripheral.

The USB IF provided the OTG 2.0 protocol in 2012 and also declared that the old OTG 1.3 protocol would expire at the end of 2012. The OTG 2.0 protocol modifies the time setting for the HNP role switching, so that an OTG device which originally supports the OTG 1.3 protocol cannot accomplish the HNP function in the OTG 2.0 environment. Thus, the hardware of an OTG device which originally supported the OTG 1.3 protocol needs to be upgraded or updated so as to communicate with an OTG device supporting OTG 2.0 protocol and perform the HNP role switching. The cost of the hardware upgrade is higher, and the period is longer. When the products are produced in large numbers, the hardware of the OTG devices have left the factory cannot be upgraded or updated. Thus, a method is required such that an OTG 1.3 device can accomplish the HNP function in the OTG 2.0 environment without updating its' hardware.

### BRIEF SUMMARY OF THE INVENTION

The invention provides a role switching method for a Universal Serial Bus (USB) On-The-Go (OTG) device and a USB OTG device, so that an OTG 1.3 device can accomplish a Host Negotiation Protocol (HNP) function in an OTG 2.0 environment.

An exemplary embodiment of a method of switching a role of a Universal Serial Bus (USB) On-The-Go (OTG) device is provided. The method comprises the steps of resetting an OTG controller of the USB OTG device when the USB OTG device receives a Host Negotiation Protocol (HNP) request sent from an link-partner; modifying a state of an ID-pin detection end of the OTG controller, wherein the ID-pin detection end is utilized to detect a type of plug of a USB cable; and switching the role of the USB OTG device between a host and a peripheral.

An exemplary embodiment of a Universal Serial Bus (USB) On-The-Go (OTG) device is provided. The USB OTG device comprises a host controller, a peripheral controller, and an OTG controller coupled to the host controller and the peripheral controller, comprising an ID-pin detection end for detecting a type of plug of a USB cable coupled to the USB OTG device, wherein the OTG controller is configured to be reset in response to a Host Negotiation Protocol (HNP) request sent from an link-partner, and to modify the state of the ID-pin detection end to control a currently enabled controller of the USB OTG device to switch between the host controller and the peripheral controller.

An exemplary embodiment of a method of switching a role of a Universal Serial Bus (USB) On-The-Go (OTG) device is provided. The method is applied for a first USB OTG device and a second USB OTG device which couple to each other through a USB cable. The first USB OTG being initially an A-host, and The second USB OTG device being initially a B-peripheral. The method comprises the steps of the second USB OTG device sending a first Host Negotiation Protocol (HNP) request to the first USB OTG device, wherein the HNP request is a request to become a host; the first USB OTG device suspending the USB bus, resetting an OTG controller of the first USB OTG device, and modifying a state of an ID-pin detection end to a B-type from an A-type, and switching a role of the first USB OTG device to the B-peripheral from the A-host; and after the second USB OTG detects that the first USB OTG device suspends the USB bus, the second USB OTG switching a role of the second USB OTG device to a B-host from the B-peripheral.

An exemplary embodiment of a system of switching a role of a Universal Serial Bus (USB) On-The-Go (OTG) device is provided. The system comprises a first USB OTG device and a second USB OTG device. The second USB OTG device is coupled to the first USB OTG device through a USB cable, wherein the first USB OTG device comprises a first host controller, a first peripheral controller, and a first OTG controller, the first USB OTG is initially an A-host, the first OTG controller is coupled to the first host controller and the first peripheral controller, the first OTG controller comprises an ID-pin detection end which is used to detect a type of plug of a USB cable coupled to the first USB OTG device; wherein the first OTG controller is configured to receive a first Host Negotiation Protocol (HNP) request sent from the second USB OTG device, suspend a USB bus, reset modify a state of an ID-pin detection end to a B-type from an A-type, and control a currently enabled controller of the first USB OTG device to switch to the first peripheral controller from the first host controller; wherein the second USB OTG device comprises a second host controller, a second peripheral controller, and a second OTG controller, the second USB OTG is initially a B-peripheral; wherein the second OTG controller is configured to switch a role of the second USB OTG device to a B-host from the B-peripheral and control a currently enabled controller of the second USB OTG device to switch to the second host controller from the second peripheral controller after detecting the first USB OTG device suspend the USB bus.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a Universal Serial Bus (USB) On-The-Go (OTG) device;

FIG. 2 is a schematic diagram illustrating the transferring of a state machine that occurs when a USB OTG device supporting the OTG 2.0 protocol switches between an A-host and an A-peripheral using the HNP protocol:

FIG. 3 is a flow chart of a first exemplary embodiment of a method of switching the role of a USB OTG device:

FIG. 4 is a schematic diagram illustrating the transferring of the state machine according to a second exemplary embodiment of a method of switching the role of a USB OTG device;

FIG. 5 is a flow chart of a third exemplary embodiment of a method of switching the role of a USB OTG device;

FIG. 6 shows an exemplary embodiment of a role switching system for a USB OTG device;

FIG. 7 shows an exemplary embodiment of a USB OTG device;

FIG. 8 shows one exemplary embodiment of the ID-pin control circuit of FIG. 7; and

FIG. 9 shows another exemplary embodiment of the ID-pin control circuit of FIG. 7.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Certain terms are used throughout the specification and following claims to refer to particular components. As one skilled in the art will appreciate, manufacturers may refer to a component by different names. The specification and following claims do not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if a first device couples to a second device, that connection may be through a direct electrical connection, through an indirect electrical connection via other devices and connections.

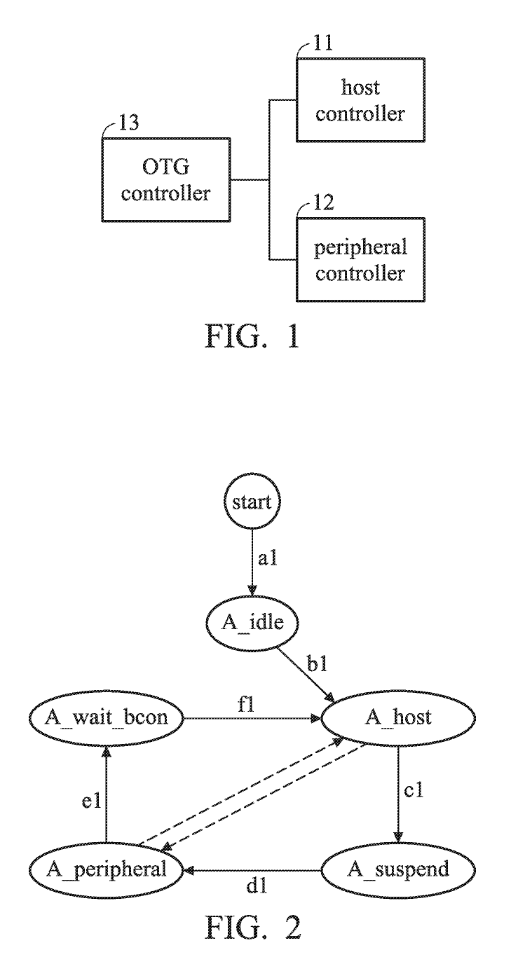

FIG. 1 shows an exemplary embodiment of a Universal Serial Bus (USB) On-The-Go (OTG) device according to the disclosure. As shown in FIG. 1, a USB OTG device generally comprises three units: a host controller 11, a peripheral controller 12, and an OTG controller 13. The OTG controller 13 controls the operation state of the USB OTG device by the state machine. According to the type (A-type or B-type) of the cable plug detected at the beginning of the power-on and the result of the HNP role switching, the OTG controller 13 can make a current operational controller to be switched between the host controller 11 and the peripheral controller 12. For example, when the state machine of the OTG controller 13 transfers to the A-host state or the B-host state, the OTG controller 13 enables the host controller 11 and disables the peripheral controller 12, so as to control the USB OTG device to be a USB host. However, when the state machine of the OTG controller 13 transfers to the A-peripheral state or the B-peripheral state, the OTG controller 13 enables the peripheral controller 12 and disables the host controller 11, so as to control the USB OTG device to be a USB peripheral.

For a detailed illustration of the role setting and the switching process for the USB OTG device, the following embodiment will describe a switching process of an UEB OTG device which supports the OTG 2.0 protocol and switches between a host and a peripheral. It should be noted that, usually, under the OTG 2.0 protocol, two connected USB OTG devices can accomplish the role switching through the HNP protocol. Specifically, when a USB OTG device whose initial role is a peripheral wants to be a host, the USB OTG device can send an HNP request to the link-partner (that is, another USB OTG device), so that the role of the link-partner switches to the peripheral from the host, while the USB OTG device switches to the host from the peripheral. When the USB OTG device finishes using the bus and wants to return to the peripheral role, the USB OTG device also sends an HNP request (that is, an HNP return request), so that the link-partner switches back to the host from the peripheral, while the USB OTG device switches back to the peripheral from the host.

FIG. 2 is a schematic diagram illustrating the transferring of the state machine when a USB OTG device supporting the OTG 2.0 protocol uses the HNP protocol to switch between an A-host and an A-peripheral. In the embodiment, it is assumed that the type of the USB cable plug which is coupled to the USB OTG device is an A-plug, and the HNP role switching is described assuming that the USB OTG device is an A-device. It should be noted that the states in the schematic diagram comprise only the necessary states which are required for accomplishing the USB OTG device switching between an A-host (A_host) role and an A-peripheral (A_peripheral) role, not all states of the OTG state machine defined by the HNP protocol.

As shown in FIG. 2, the transferring process of the state machine comprises not only a start state but also five states: an A-idle (A_idle) state, an A-host (A_host) state, A-suspend state (A_suspend), an A-peripheral (A_peripheral) state, and an A-wait (A_wait_bcon) state. Since it is assumed that the type of plug of the USB cable which is coupled to the USB OTG device is an A-plug, the OTG controller transfers to the A_idle state from the start state at the beginning of the power-on (step a1). Since the predetermined role corresponding to the A-plug is a USB host, at the A_idle state, the OTG state machine automatically transfers to the A_host state to set the USB OTG device as a USB host (step b1). Then, when the USB OTG device receives an HNP request sent by the link-partner (which means that the link-partner has a requirement for being a host), the OTG controller controls the USB OTG device to suspend the USB bus and to yield the control authority of the bus and transfers the OTG state machine to the A_suspend state (step c1). When the OTG controller detects that the link-partner obtains the control authority of the bus, the OTG controller controls the OTG state machine to transfer to the A_peripheral state and switches the role of the USB OTG device to a USB peripheral (step d1). Thus, one role switching process is achieved. Then, when the link-partner finishes using the USB bus, the link-partner also suspends the SUB bus. Thus, when the OTG controller detects that the USB bus is suspended, the OTG controller controls the OTG state machine to enter the A_wait_bcon state to prepare to remaster the control authority of the bus (step e1). Finally, after waiting for a period, the OTG controller controls the OTG state machine to re-transfer to the A_host state (step f1), and the USB OTG device switches to the host role from the USB peripheral role.

In the embodiment, when receiving an HNP request for the first time, an USB OTG device whose initial role is host transfers to the A_peripheral state from the A_host state: when receiving an HNP request for the second time, the USB OTG device transfers back to the A_host state from the A_peripheral state. On the contrary, for the opposite-end USB OTG device, the role transferring process includes: transferring to the B_host state from the B_peripheral state and then transferring back to the B_peripheral state from the B_host state. Thus, the two connected USB OTGs maintain a state that one is a host and the other is a peripheral.

The transfer process of the state machine for the HNP switching defined by the OTG 1.3 protocol is identical to that defined by OTG 2.0 protocol. In other words, under the OTG 1.3 environment and the OTG 2.0 environment, a USB OTG device accomplish the HNP switching through the same process. However, the difference between the OTG 1.3 protocol and the OTG 2.0 protocol is that the time setting of the HNP role switching is modified in the OTG 2.0 protocol. Specifically, the value of the time parameter T_{A}_{_}_{BDIS}_{_}_{ACON} in the OTG 2.0 protocol changes to 150 ms from 3 ms defined in the OTG 1.3 protocol. The time parameter T_{A}_{_}_{BDIS}_{_}_{ACON} indicates the time required for a USB OTG device to enter the B_host state from the B_peripheral state. Specifically, when a USB OTG device switches to the A_peripheral state from the A_suspend state, an link-partner has to switch to the B_host state from the B_peripheral state. After the USB OTG device switches to the A_peripheral state from the A_suspend state and yields the control authority of the bus, the USB OTG device detects whether the link-partner enters the B_host state in time. If the USB OTG device does not detect the link-partner enters the B_host state within the time T_{A}_{_}_{BDIS}_{_}_{ACON}, it will take the control authority of the bus again, return back to the A_host state, and send the message “HNP failed”.

As described above, since the value of the parameter time T_{A}_{_}_{BDIS}_{_}_{ACON} to 150 ms from 3 ms in the OTG 2.0 protocol, the time required for an link-partner to enter the B_host state is lengthened greatly. Thus, when a USB OTG device supporting the OTG 1.3 protocol (i.e., OTG 1.3 device) communicates with a USB OTG device supporting the OTG 2.0 protocol (i.e., OTG 2.0 device), the OTG 1.3 device shortly enters the A_peripheral state and then returns to the A_host state, which causes the HNP switching to fail. Specifically, after the USB OTG 1.3 device switches to the A_peripheral state from the A_suspend state, the opposite-end USB OTG 2.0 device takes a longer time (150 ms) to enter the B_host state. At this time, since the time parameter time T_{A}_{_}_{BDIS}_{_}_{ACON} set by the USB OTG 1.3 device is too short, the USB OTG 1.3 device does not detect that the link-partner enters the B_host state within 3 ms. Thus, the USB OTG 1.3 device returns back to the A_host state, which causes the HNP switching to fail.

Thus, a USB OTG 1.3 device wants to accomplish the HNP switching under the OTG 2.0 environment, the setting of the time parameter T_{A}_{_}_{BDIS}_{_}_{ACON} for the USB OTG 1.3 device should be modified. However, for most USB OTG 1.3 devices, the value of time parameter T_{A}_{_}_{BDIS}_{_}_{ACON} is fixed in the read-only circuits within the chips during the Manufacturing process, and there are no interfaces provided to users to modify it. Thus, for devices which have manufactured, the time parameters T_{A}_{_}_{BDIS}_{_}_{ACON} cannot be modified. Other techniques should be provided if the hardware of a USB OTG 1.3 device needn't to be changed and USB OTG 1.3 device also can accomplish HNP switching under an OTG 2.0 environment.

The invention provides an embodiment of a method for a USB OTG 1.3 device to accomplish HNP switching under an OTG 2.0 environment by changing the transfer process of the state machine of the HNP switching. An OTG controller can automatically set the corresponding USB OTG device as an A-host or a B-peripheral according to the detected plug type of the USB cable. Moreover, the behavior of the bus is identical for the A_host and B_host states, or for the A_peripheral-device and B_peripheral-device states. Based on the behavior of the bus, a link-partner is not capable of distinguishing the A_host state from the B_host state, or distinguishing the A_peripheral-device state from the B_peripheral-device state. Thus, according to the above characteristics, the transfer process of the state machine of the HNP switching can be changed by inserting a reset operation in the transfer process of the state machine. In the following, the method for a USB OTG 1.3 device to accomplish HNP switching under the OTG 2.0 environment by changing the transfer process of the state machine of the HNP switching will be described.

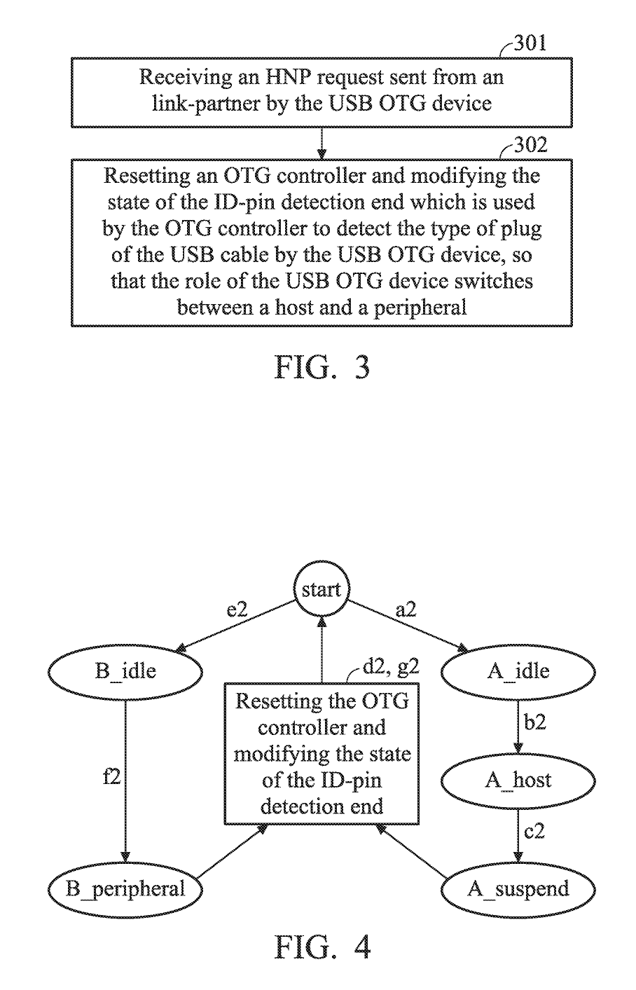

FIG. 3 is a flow chart of a first exemplary embodiment of a method of switching the role of a USB OTG device. The method comprises the following steps:

Step 301: the USB OTG device receives an HNP request sent from a link-partner;

Step 302: the USB OTG device resets an OTG controller and modifies the state of the ID-pin detection end which is used by the OTG controller to detect the type of plug of the USB cable:

Step 303: the USB OTG device switches the role of the USB OTG device between a host and a peripheral.

Specifically, in the embodiment, when the USB OTG device receives an HNP request sent from the link-partner, the USB OTG device resets the OTG controller. In more detail, the USB OTG device resets the state machine of the OTG controller; that is, the USB OTG device makes the state machine of the OTG controller return to the start state. Furthermore, in the embodiment, after the USB OTG device resets the OTG controller, the USB OTG device modifies the state of the ID-pin detection end which is used by the OTG controller to detect the type of plug of the USB cable. For example, by switching a detected type of plug of the USB cable. For example, if the type of plug of the USB cable which is originally detected by the ID-pin detection end is the A-type, the USB OTG device modifies it to the B-type. If the type of plug of the USB cable which is originally detected by the ID-pin detection end is the B-type, the USB OTG device modifies it to the A-type. At the start state, the OTG controller will re-detect the type of plug of the USB cable which the USB OTG device is coupled to. Thus, if the type of plug of the USB cable is modified by the USB OTG device, the re-detected type of plug of the USB cable will change too. As described above, the OTG controller can automatically set the USB OTG device as an A-host or a B-peripheral according to the detected plug type of the USB cable. Thus, through modifying the type of plug of the USB cable which is detected by the OTG controller, the role of the USB OTG device can switch to the peripheral from the original host or to the host from the original peripheral. Finally, the role of the USB OTG device switches between the host and the peripheral.

In the embodiment, after the USB OTG device receives an HNP request sent from the link-partner, the USB OTG device resets the OTG controller, so that the OTG controller can re-detect the type of plug of the USB cable. Meanwhile, the USB OTG device modifies the state of the ID-pin detection end which is used by the OTG controller to detect the type of plug of the USB cable, so that the OTG controller can detect the modified type of plug of the USB cable and further change the role of the USB OTG device according on the detection result corresponding to the modified type of the USB cable. Accordingly, the role of the USB OTG device can switch between a host and a peripheral.

According to the embodiment, only the transferring process of the state machine of the OTG controller is changed. However, changing the transferring processor of the state machine of the OTG controller can be accomplished by modifying the configuration of the software of the OTG device, the hardware circuit of the USB OTG device does not need to be changed. Thus the invention significantly reduces the cost. Furthermore, only some states (A_host/B_host state, A_peripheral-device/B_peripheral-device state) are exhibited on the bus during the transferring process of the OTG state machine, and the link-partner can only observe these states. In other words, the link-partner is only concerned about whether the HNP switching result is the USB OTG device switches between the host role and the peripheral role. The link-partner does not care how the OTG controller controls the transferring of the state machine for accomplishing the role switching. Thus, the embodiment is capable of successfully accomplishing the OTG role switching by simulating the HNP principle, but the link-partner is not aware of this simulation operation.

FIG. 4 is a schematic diagram illustrating the transferring of the state machine according to a second exemplary embodiment of a method of switching the role of a USB OTG device. It is assumed that the USB OTG device of this embodiment is a USB OTG 1.3 device which has an updated software configuration, the type of plug of the USB cable connecting with the USB OTG device is A-type, a link-partner of the USB OTG device is a USB OTG 2.0 device, and the type of plug of the USB cable connecting with the link-partner is B-type. As shown in FIG. 4, the transferring process of the state machine begins from the start state. When the power is on initially, the OTG controller automatically transfers to the A_idle state from the start state according to the detected plug type of the cable (step a2). Since the default role corresponding to the A-plug is a USB host, the OTG state machine automatically transfers to the A_host state after at the A_idle state (step b2). Then, when the USB OTG device receives an HNP request sent from the link-partner (which means that the link-partner has a requirement for being a host), the OTG controller controls the USB OTG device to suspend the USB bus and to yield the control authority of the bus and transfers the OTG state machine to the A_suspend state (step c2).

The above three steps are the same as the first three steps of the USB OTG 2.0 device shown in FIG. 2. Based on the reason that the time parameter T_{A}_{_}_{BDIS}_{_}_{ACON} in the OTG 1.3 protocol is different from the time parameter T_{A}_{_}_{BDIS}_{_}_{ACON} in the OTG 2.0 protocol, when the USB OTG 1.3 does not detect that the link-partner enters the B_host state within 3 ms, the USB OTG 1.3 will return to the A_host state. However, in step d2 of the embodiment, the USB OTG device will directly reset the OTG controller instead of return to the A_host state. Specifically, the USB OTG device sets the reset terminal of the USB OTG device through a reset controller, so that the OTG state machine returns to the start state. Then, the USB OTG device modifies the state of the ID-pin detection end which is used by the OTG controller to detect the type of plug of the USB cable. Specifically, the state of the ID-pin detection end is modified to the B-type from the A-type, so that the OTG state machine automatically transfers to the B_idle state.

It should be noted that, in the OTG protocol, both of the A_idle state and the B_idle state belong to the idle state, and the behavior characteristics of the two states are identical. The only difference between them is that the A_idle state is preset to transfer to the A_host state while the B_idle state is preset to transfer to B_peripheral-device state. Also, how the USB OTG device modifies the ID-pin detection end for switching between the A-type and the B-type will be described in the following embodiments.

Referring to the OTG state machine of FIG. 4, after step d2, the OTG state machine returns to the start state, and the state of the ID-pin detection end is modified to the B-type, the OTG controller automatically transfers to the A_idle state from the start state according to the detected plug type of the cable (step e2). Then, the OTG state machine automatically transfers to the B_peripheral-device state (step f2). Accordingly, the USB OTG device successfully responds to the HNP request and switches to the peripheral role from the host role. Different from the transferring process of the state machine of FIG. 2, the USB OTG device of the embodiment transfers to the B-peripheral role from A-host role (not to the A-peripheral role). However, the behavior of the bus is identical for the A_host and B_host states or for the A_peripheral-device and B_peripheral-device states. The link-partner is not capable of distinguishing the A_peripheral-device state from the B_peripheral-device state based on the behavior of the bus. Thus, the link-partner “believes” that the USB OTG had transferred to the A_peripheral state from the A_host state. The process of the transfer cannot disadvantageously affect the HNP function of the UEB OTG device.

Then, when the link-partner finishes using the USB bus and wants to return to the peripheral role, the link-partner will suspend the SUB bus and send an HNP request. In the embodiment, when the USB OTG device detects the condition (i.e., detects the link-partner send an HNP request), the USB OTG device also directly resets the OTG controller(step g2) from the B_peripheral-device state, so that the OTG state machine returns to the start state again. Meanwhile, the USB OTG device modifies the state of the ID-pin detection end which is used by the OTG controller to detect the type of plug of the USB cable again (step g2). Specifically, the state of the state of the ID-pin detection end is modified back to the A-type from the B-type, so that the OTG state machine automatically transfers to the A_idle state (step a2) and automatically transfers to the A_host state from the A_idle state (step b2). Accordingly, another process for switching to the host role from the peripheral role is accomplished.

As described above, the transferring process of the state machine is changed by modifying the software configuration of the USB OTG device. Thus, after the USB OTG device receives an HNP request, the USB OTG device can switch between the A-host and B-peripheral through modifying state of the ID-pin detection end which is used by the OTG controller to detect the type of plug of the USB cable. In the embodiment, there is no need to change the hardware circuit of the USB OTG device. The change of the transferring processor of the state machine of the OTG controller is accomplished only by modifying the configuration of the software, which significantly reduces the cost. Moreover, according to the embodiment, a USB OTG 1.3 device can successfully simulate the HNP principle defined by the OTG 2.0 protocol for accomplishing the OTG role switching, and the link-partner is not aware of this simulation operation.

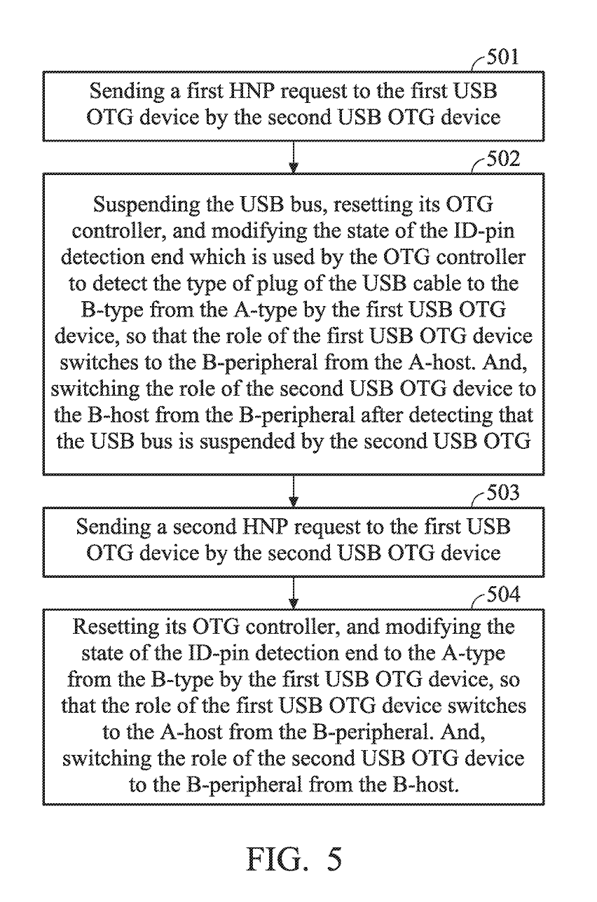

FIG. 5 is a flow chart of a third exemplary embodiment of a method of switching the role of a USB OTG device. As shown in FIG. 5, the method is applied to a first USB OTG device and a second USB OTG device. It is assumed that the first USB OTG device is coupled to an A-plug of a USB cable, and the second USB OTG device is coupled to a B-plug of the USB cable. That is, the first OTG device initially serves as an A-host, while the second USB OTG device initially serves as an B-peripheral. The first USB OTG device is a USB OTG device which supports the OTG 1.3 protocol, while the second USB OTG device is a USB OTG device which supports the OTG 2.0 protocol. The embodiment will describe the process of HNP role switching for the USB OTG 1.3 device whose initial role is a host and the USB OTG 2.0 device whose initial role is a peripheral. The method comprises the following steps:

Step 501: the second USB OTG device sends a first HNP request to the first USB OTG device, wherein the first HNP request is used as a request to become a host.

Step 502: the first USB OTG device suspends the USB bus, resets its OTG controller, and modifies the state of the ID-pin detection end which is used by the OTG controller to detect the type of plug of the USB cable to the B-type from the A-type, so that the role of the first USB OTG device switches to the B-peripheral from the A-host. After the second USB OTG detects that the USB bus is suspended, the role of the second USB OTG device switches to the B-host from the B-peripheral.

In step 502, the first USB OTG device switches to the B_peripheral_device state from the A_host state, and the specific switching process can be obtained by referring to the transferring process of the state machine shown in FIG. 4. The second USB OTG device switches to the B_host state from the B_peripheral state. Since the second OTG USB device supports the OTG 2.0 protocol, the second OTG USB device achieves role switching just by performing the transfer process defined by the OTG 2.0 protocol. In the embodiment, the transferring process of the OTG state machine of the second USB OTG device is not changed.

Step 503: the second USB OTG device sends a second HNP request to the first USB OTG device, wherein the second HNP request is used as a request to return to a peripheral from the host.

Step 504: the first USB OTG device resets its OTG controller, and modifies the state of the ID-pin detection end to the A-type from the B-type, so that the role of the first USB OTG device switches to the A-host from the B-peripheral. Moreover, the role of the second USB OTG device switches to the B-peripheral from the B-host.

In step 504, when the first USB OTG device detects that the second USB OTG is disconnected from the USB bus; that is, equivalently, when the first USB OTG device receives an HNP_back request (the second HNP request) sent from the second USB OTG device, the first USB OTG device switches the OTG state machine to the A_host state from the B_peripheral state. The specific switching process can be obtained by referring to the transferring process of the state machine shown in FIG. 4. The second USB OTG device switches to the B_peripheral state from the B_host state. Since the second OTG USB device supports the OTG 2.0 protocol, in step S504, the second OTG USB device achieves role switching just by performing the transfer process defined by the OTG 2.0 protocol.

The behavior of the bus is identical for the A_host and B_host states, or for the A_peripheral-device and B_peripheral-device states. Thus, in the method of the embodiment, the second USB OTG device is not capable of distinguishing the A_peripheral-device state from the B_peripheral-device state based on the behavior of the bus. That is, the second USB OTG device “believes” that the first USB OTG has transferred to the A_peripheral state from the A_host state and then transferred back to the A_host state from the A_peripheral state. Thus, by changing the transferring process of the state machine of the first USB OTG device, the USB OTG 1.3 device successfully simulates the HNP principle defined by the OTG 2.0 protocol for accomplishing the OTG role switching, but the link-partner is not aware of this simulation operation.

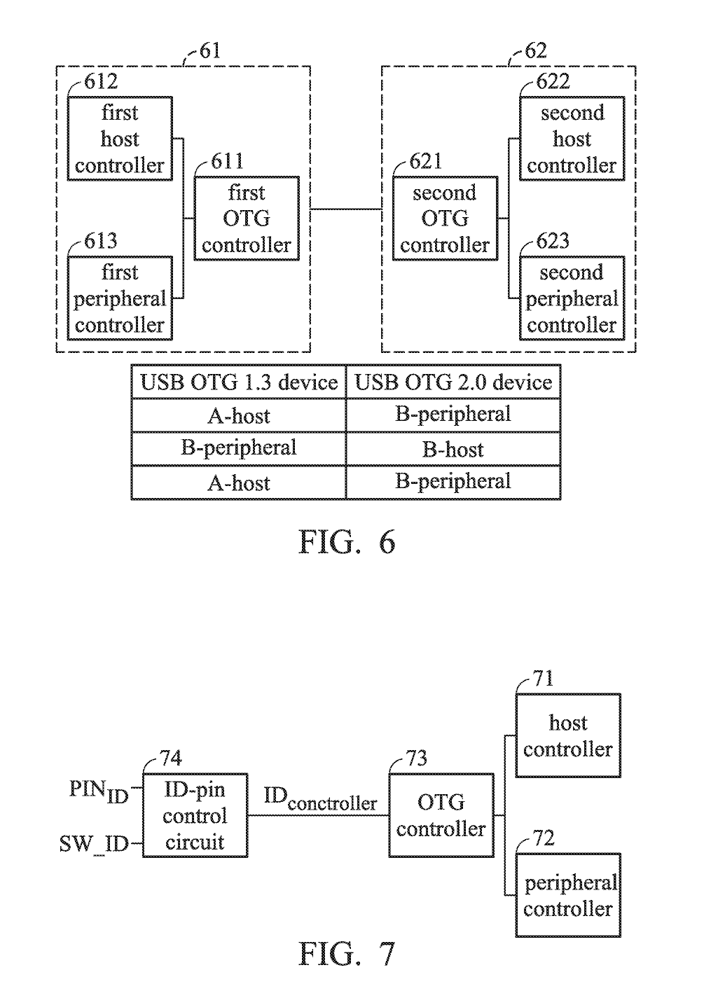

FIG. 6 shows an exemplary embodiment of a role switching system for a USB OTG device. The system in the embodiment of FIG. 6 is applied to the method shown in FIG. 5. As shown in FIG. 6, the role switching system comprises a first USB OTG device 61 and a second USB OTG device 62. The first USB OTG device is a USB OTG device which supports the OTG 1.3 protocol, while the second USB OTG device is a USB OTG device which supports the OTG 2.0 protocol.

The first USB OTG device 61 comprises a first OTG controller 611, a first host controller 612. and a first peripheral controller 613. The first OTG controller 611 is coupled to the first host controller 612 and the first peripheral controller 613. After the first USB OTG device 61 receives a first HNP request which is sent from the second USB OTG device 62 and used as a request to become a host, the first OTG controller 611 is reset and modifies the state of the ID-pin detection end which is used by the first OTG controller 611 to detect a type of plug of a USB cable to the B-type from the A-type, so that the role of the first USB OTG device 61 switches to the B-peripheral from the A-host, and the controller which is currently enabled switches to the first peripheral controller 613 from the first host controller 612. Moreover, after the first USB OTG device 61 receives a second HNP request which is used as a request to return to a peripheral from the host, the first OTG controller 611 is reset again and modifies the state of the ID-pin detection end which is used by the first OTG controller 611 to detect a type of plug of a USB cable to the A-type from the B-type, so that the role of the first USB OTG device 61 switches to the A-host from the B-peripheral, and the controller which is currently enabled switches to the first host controller 612 from the first peripheral controller 613.

The second USB OTG device 62 comprises a second OTG controller 621, a second host controller 622, and a second peripheral controller 623. The second OTG controller 621 is coupled to the second host controller 622 and the second peripheral controller 623. After the second USB OTG device 62 sends the first HNP request to the first USB OTG device 61, the second OTG controller 612 switches the role of the second USB OTG device 62 to the B-host from the B-peripheral and switches the controller which is currently enabled to the second host controller 622 from the second peripheral controller 623. Moreover, after the second USB OTG device 62 sends the second HNP to the first USB OTG device 61, it switches the role of the second USB OTG device 62 to the B-peripheral from the B-host and switches the controller which is currently enabled to the second peripheral controller 623 from the second host controller 622.

In the embodiment, how to accomplish the process of the role switching for the first USB OTG device 61 and the second USB OTG device 62 can be obtained by referring to the above embodiment of the method of FIG. 5. For a clear illustration, the related description is omitted.

In the following, an embodiment is provided to describe how a USB OTG device modifies the state of an ID-pin detection end to make an OTG controller to detect that the type of a USB cable switches between an A-type and a B-type. FIG. 7 shows an exemplary embodiment of a USB OTG device. As shown in FIG. 7, a USB OTG device comprises a host controller 71, a peripheral controller 72, and an OTG controller 73. The OTG controller 73 is coupled to the host controller 71 and the peripheral controller 72. The OTG controller 73 comprises an ID-pin detection end ID_{controller} for detecting the type of a plug of a USB cable connected to the USB OTG device. When the OTG device receives an HNP request sent from a link-partner, the OTG controller 73 makes a response to the HNP request, operates in a reset mode, and modifies the state of the ID-pin detection end to control the controller of the USB OTG device which is currently at an enable state to switch between the host controller 71 and the peripheral controller 72; that is, to control the role of the USB OTG device to switch between a host and a peripheral. Specifically, in the embodiment. When the OTG controller 73 receives the HNP request sent from the link-partner, the OTG controller 73 is reset; that is, the state machine of the OTG controller 73 is reset, so that the state machine returns to the start state. At the start state, the OTG controller 72 re-detects the type of plug of the connected USB cable through the ID-pin detection end ID_{conctroller}. Furthermore, after the OTG controller 73 is reset, the OTG controller 73 modifies the state of the ID-pin detection end ID_{conctroller}. For example, if the type of plug of the USB cable which is originally detected by the ID-pin detection end ID_{conctroller} is the A-type, the OTG controller 73 modifies it to the B-type. If the type of plug of the USB cable which is originally detected by the ID-pin detection end ID_{conctroller} is the B-type, the OTG controller 73 modifies it to the A-type. The OTG controller 73 can automatically enable the host controller 71 or the peripheral controller 72 to operate according to the detected type of plug of the USB cable to set the USB OTG device as an A-host or a B-peripheral. Thus, by modifying the type of plug of the USB cable which is detected by the OTG controller 73, the role of the USB OTG device switches to a peripheral from the original host or to a host from the original peripheral for accomplishing switching between the host and the peripheral. The USB OTG device of the embodiment further comprises an ID-pin control circuit 74. The ID-pin control circuit 74 connects between an ID pin PIN_{ID} of the USB cable which is coupled to the USB OTG device and the ID-pin detection end ID_{conctroller} of the OTG controller 73. The method used by the OTG controller 73 to modify the detected type of plug of the USB cable through the ID-pin detection end ID_{conctroller} comprises the step of controlling, through the ID-pin control circuit 74, the state value which is input to the ID-pin detection end ID_{conctroller} to switch between the state value of the ID pin PIN_{ID} and an inverse state value SW_ID. Specifically, the state of the ID-pin detection end ID_{conctroller} comprises ground and floating whose corresponding state values respectively comprise a low voltage level and a high voltage level. The state value SW_ID is always inverse to the state value of the ID pin PIN_{ID}. In other words, when the type of plug of the USB cable which is coupled to the USB OTG device is the A-type, the state value of the ID pin PIN_{ID} is Low voltage level, while the state value of the SW_ID is High voltage level. When the type of plug of the USB cable which is coupled to the USB OTG device is the B-type. the state value of the ID pin PIN_{ID} is a High voltage level, while the state value of the SW_ID is Low voltage level. After the USB OTG device of the embodiment receives the HNP request from the link-partner, the USB OTG device resets the OTG controller 73, so that the USB controller can modify the state of the ID-pin detection end which is used by the OTG controller 73 to detect a type of plug of a USB cable and re-detect the type of plug of the connected USB cable. Thus, the OTG controller is capable of modifying the role of the USB OTG device according to the re-detected, modified type of plug of the USB cable, so that the role of the USB OTG device can switch between the host and the peripheral. For the embodiment, there is no need to change the hardware circuit of the USB OTG device, and only the transferring process of the state machine of the OTG controller is changed so that the USB OTG 1.3 device simulates the HNP principle of the OTG 2.0 protocol, which significantly lowers the cost. FIG. 8 shows one exemplary embodiment of the ID-pin control circuit 74 of FIG. 7. As shown in FIG. 8, the ID-pin control circuit 74 comprises a multiplexer 741, an internal storage 742, and a state-value controller 743. The multiplexer 741 is connected between the ID pin PIN_{ID} of the USB cable and the ID-pin detection end ID_{conctroller} of the OTG controller 73. Specifically, the first input terminal of the multiplexer 741 is coupled to the ID pin PIN_{ID}, the output terminal thereof is coupled to the ID-pin detection end ID_{conctroller} of the OTG controller 73, and the second input terminal thereof receives an input state value SW_ID. The input state value SW_ID is provided by the internal storage 742.

The state-value controller 743 is coupled to the internal storage 742, the enable control terminal of the multiplexer 741. the ID pin PIN_{ID} of the USB cable, and the OTG controller 73. Specifically, when the USB OTG device is coupled to the plug of the USB cable, the state-value controller 743 detects the state value (a high voltage level or low voltage level) of the ID pin PIN_{ID} of the USB cable and writes a state value inverse (a low voltage level or a high voltage level) to the detected state value of the ID pin PIN_{ID} into the internal storage 742. Moreover, when the USB OTG device receives an HNP request from a link-partner, according to the indication of the OTG controller 73, the state-value controller 743 further controls the output of the multiplexer 741 to switch between the state value of the ID pin PIN_{ID} and the state value provided by the internal storage through the enable control terminal of the multiplexer 741. Specifically, when the USB OTG device receives an HNP request sent from a link-partner, the OTG controller 73 is reset and controls the state-value controller 743 to switch the output of the multiplexer 741. At this time, the state-value controller 743 outputs a corresponding enable signal SW_IN_EN to the enable control terminal of the multiplexer 741, so that the multiplexer 741 selects the signal at the first input terminal or the second input terminal to serve as the output signal. For example, when the enable signal SW_IN_EN is “0”, the multiplexer 741 selects the state value of the ID pin PIN_{ID} to serve as the output provided to the ID pin detection terminal of the OTG controller 73; when the enable signal SW_IN_EN is “1”, the multiplexer 741 selects the state value provided by the internal storage 742 to serve as the output provided to the ID pin detection terminal of the OTG controller 73. It should be noted that the embodiment is provided as an example, without limitation to the invention. One skilled in the art can apply other configurations according to actual requirements.

In the embodiment, all of the units/modules in the ID-pin control circuit 74 can be integrated into a chip with the OTG controller 73. the host controller 71, and the peripheral controller 72. In another embodiment, only the internal storage 742 and the state-value controller 743 in the ID-pin control circuit 74 are integrated into a chip with the OTG controller 73, the host controller 71, and the peripheral controller 72. The multiplexer 741 is independent to the chip; that is, the multiplexer 741 is disposed externally to the chip. At this time, both the output signal SW_IN_EN of the state-value controller 743 and the output signal SW_ID of the internal storage 742 are output to the multiplexer 741 through the output pin of the chip. One skilled in the art will know that the above embodiments are examples without limitations to the invention. One skilled in the art can take other configurations according to actual requirements.

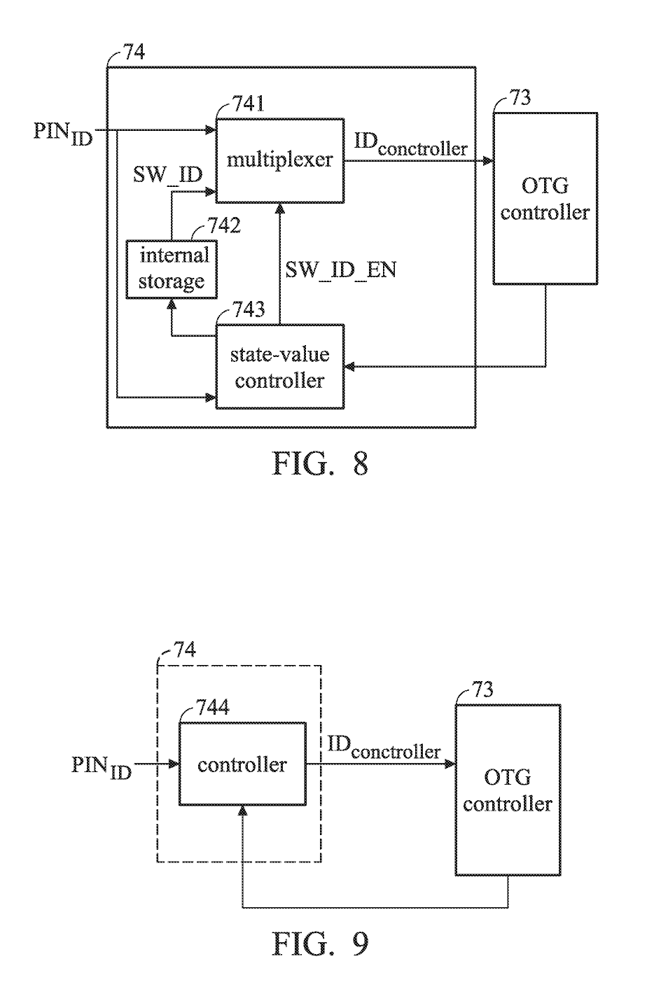

FIG. 9 shows another exemplary embodiment of the ID-pin control circuit 74 of FIG. 7. In the embodiment, the ID-pin control circuit 74 comprises a controller 744. The controller 744 is coupled to the ID pin PIN_{ID} of the USB cable, an output of the OTG controller 73, and the ID-pin detection end ID_{conctroller} of the OTG controller 73. The controller 744 is configured to output a corresponding state value to the ID-pin detection end ID_{conctroller} of the OTG controller 73 directly according to the current state of the state machine of the OTG controller 73. Specifically, when the current state of the state machine of the OTG controller 73 is the start state, the controller 744 outputs the detected state value of the ID pin PIN_{ID} to the ID-pin detection end ID_{conctroller}, so that the OTG controller can normally detect the type of plug of the USB cable connecting with the OTG controller. When the current state of the state machine of the OTG controller 73 is the A_host or A_suspend state and the OTG controller 73 has received an HNP request from the link-partner, the controller 744 directly outputs a state value “1” (a high voltage level) to the ID-pin detection end ID_{conctroller}, so that the OTG controller 73 then can transfer to the B_peripheral state. When the current state of the state machine of the OTG controller 73 is the B_suspend state and the OTG controller 73 has received an HNP request from the link-partner, the controller 744 outputs the state value “1” (the high voltage level) to the ID-pin detection end ID_{conctroller}. so that the OTG controller 73 then can transfer to the A_host state.

In the embodiment, the controller 744 is disposed in the chip where the USB OTG controller is located, and the outputting to the OTG controller 73 from the controller 744 is achieved through the general purpose input/output (GPIO) of the chip.

In the above embodiments, two examples are provided to illustrate that the USB OTG device modifies the state of the ID-pin detection end to make the OTG controller detect that the type of plug of the USB cable switches between the A-type and the B-type. However, it should be noted that the examples are not limitations of the invention. According to actual requirements, one skilled in the art can perform other configurations which fall within the scope of the appended claims without departing from the spirit of the present invention.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of switching a role of a Universal Serial Bus (USB) On-The-Go (OTG) device, comprising:
resetting an OTG controller of the USB OTG device when the USB OTG device receives a Host Negotiation Protocol (HNP) request sent from a link-partner; modifying a state of an ID-pin detection end of the OTG controller, wherein the ID-pin detection end is utilized to detect a type of plug of a USB cable; and
switching the role of the USB OTG device between a host and a peripheral.

2. The method as claimed in claim 1,
wherein the step of modifying the state of the ID-pin detection end of the OTG controller comprises:
modifying the state of the ID-pin detection end of the OTG controller by switching a detected type of plug of the USB cable between an A-type and a B-type; and
wherein the step of switching the role of the USB OTG device between the host and the peripheral comprises:
switching the role of the USB OTG device between an A-host and a B-peripheral.

3. The method as claimed in claim 2 further comprising:
when the role of the USB OTG device is the A-host and the USB OTG device receives the HNP request sent from the link-partner, resetting the OTG controller and modifying the state of the ID-pin detection end of the OTG controller by switching the detected type of plug of the USB cable to the B-type from the A-type and switching the role of the USB OTG device to the B-peripheral from the A-host; and
when the role of the USB OTG device is the B-peripheral and receives the HNP request sent from the link-partner, resetting the OTG controller and modifying the state of the ID-pin detection end of the OTG controller by switching the detected type of plug of the USB cable to the A-type from the B-type and switching the role of the USB OTG device to the A-host from the B-peripheral.

4. The method as claimed in claim 1, wherein the step of modifying the state of the ID-pin detection end of the OTG controller comprises:
modifying the state of the ID-pin detection end of the OTG controller by switching the state of the ID-pin detection end between a ground and a floating.

5. The method as claimed in claim 1, wherein the step of modifying the state of the ID-pin detection end of the OTG controller comprises:
using an ID-pin control circuit to control a state value input to the ID-pin detection end to switch between a state value of an ID pin of the plug of the USB cable connecting with the USB OTG device and a state value which is inverse to the state value of the ID pin;
wherein the state value of the ID pin comprises a high voltage level and a low voltage level.

6. The method as claimed in claim 5,
wherein the ID-pin control circuit comprises a multiplexer, comprising a first input terminal coupled to the ID pin of the USB cable, an output terminal coupled to the ID-pin detection end, and a second input terminal for receiving an input state value being inverse to the state value of the ID pin of the plug of the USB cable, and
wherein the step of using an ID-pin control circuit to control a state value input to the ID-pin detection end comprises:
controlling an output of the multiplexer to switch between a signal at the first input terminal and a signal at the second input terminal.

7. The method as claimed in claim 6,
wherein the ID-pin control circuit further comprises an internal storage coupled to the second input terminal of the multiplexer for providing the input state value, and a state-value controller coupled to the internal storage, an enable terminal of the multiplexer, the ID pin of the plug of the USB cable, and the OTG controller, and
wherein the method further comprises:
when the USB OTG device is coupled to the USB cable, the state-value controller detecting the state value of the ID pin of the plug of the USB cable and writing a state value which is inverse to the detected state value of the ID pin into the internal storage; and
when the USB OTG device receives the HNP request sent from the link-partner, the state-value controller, which is indicated by the OTG controller, controlling the output of the multiplexer to switch between the state value of the ID pin and a state value of the internal storage through the enable control terminal of the multiplexer.

8. The method as claimed in claim 5,
wherein the ID-pin control circuit comprises a state-value controller coupled to the ID pin of the USB cable, an output of the OTG controller, and the ID-pin detection end,
wherein the method further comprises:
the state-value controller outputting a corresponding state value to the ID-pin detection end according to a current state of a state machine of the OTG controller;
when the current state of the state machine of the OTG controller is a start state, the state-value controller outputting the detected state value of the ID pin to the ID-pin detection end;
when the current state of the state machine of the OTG controller is an A-host state or an A-suspend state, the state-value controller outputting a state value “1” to the ID-pin detection end; and
when the current state of the state machine of the OTG controller is an A-host state or an A-suspend state, the state-value controller outputting a state value “0” to the ID-pin detection end.

9. A Universal Serial Bus (USB) On-The-Go (OTG) device, comprising:
a host controller;
a peripheral controller;
an OTG controller, coupled to the host controller and the peripheral controller, comprising an ID-pin detection end for detecting a type of plug of a USB cable coupled to the USB OTG device,
wherein the OTG controller is configured to be reset in response to a Host Negotiation Protocol (HNP) request sent from a link-partner, and to modify the state of the ID-pin detection end to control a currently enabled controller of the USB OTG device to switch between the host controller and the peripheral controller.

10. The USB OTG device as claimed in claim 9, wherein the OTG controller is further configured to modify the state of the ID-pin detection end by switching a detected type of plug of the USB cable between an A-type and a B-type to control a currently enabled controller of the USB OTG device to switch between the host controller and the peripheral controller.

11. The USB OTG device as claimed in claim 9 further comprises:
an ID-pin control circuit, coupled between an ID pin of the plug of the USB cable, which is coupled to the USB OTG device, and the ID-pin detection end of the OTG controller,
wherein the ID-pin control circuit is configured to control a state value input to the ID-pin detection end to switch between a state value of the ID pin and a state value which is inverse to the state value of the ID pin, wherein the state value of the ID pin comprises a high voltage level and a low voltage level.

12. The USB OTG device as claimed in claim 11, wherein the ID-pin control circuit comprises:
a multiplexer, comprising a first input terminal coupled to the ID pin of the USB cable, an output terminal coupled to the ID-pin detection end, and a second input terminal for receiving an input state value being inverse to the state value of the ID pin of the plug of the USB cable, and,
wherein the multiplexer is configured to select a signal at the first input terminal or a signal at the second input terminal to be output to the ID-pin detection end under the control of the OTG controller.

13. The USB OTG device as claimed in claim 12,
wherein the ID-pin control circuit further comprises an internal storage coupled to the second input terminal of the multiplexer for providing the input state value, and a state-value controller coupled to the internal storage, an enable terminal of the multiplexer, the ID pin of the plug of the USB cable, and the OTG controller, and
wherein when the USB OTG device is coupled to the USB cable, the state-value controller is configured to detect the state value of the ID pin of the plug of the USB cable and write a state value which is inverse to the detected state value of the ID pin into the internal storage, and
wherein when the USB OTG device receives the HNP request sent from the link-partner, the state-value controller is configured to control the output of the multiplexer to switch between the state value of the ID pin and a state value of the internal storage through the enable control terminal of the multiplexer under the indication of the OTG controller.

14. The USB OTG device as claimed in claim 13, wherein the multiplexer, the internal storage, and the state-value controller are integrated into a chip where the USB OTG controller is located.

15. The USB OTG device as claimed in claim 13, wherein the internal storage and the state-value controller are integrated into a chip where the USB OTG controller is located, and the multiplexer is disposed and independent from the chip where the USB OTG controller is located.

16. The USB OTG device as claimed in claim 11,
wherein the ID-pin control circuit comprises a state-value controller which is coupled to the ID pin of the USB cable, an output of the OTG controller, and the ID-pin detection end,
wherein the state-value controller is configured to output a corresponding state value to the ID-pin detection end according to a current state of a state machine of the OTG controller,
wherein when the current state of the state machine of the OTG controller is a start state, the state-value controller is configured to output the detected state value of the ID pin to the ID-pin detection end,
wherein when the current state of the state machine of the OTG controller is an A-host state or an A-suspend state, the state-value controller is configured to output a state value “1” to the ID-pin detection end, and
wherein when the current state of the state machine of the OTG controller is an A-host state or an A-suspend state, the state-value controller is configured to output a state value “0′” to the ID-pin detection end.

17. The USB OTG device as claimed in claim 16, wherein the state-value controller is integrated into a chip where the USB OTG controller is located.

18. A method of switching a role of a Universal Serial Bus (USB) On-The-Go (OTG) device for a first USB OTG device and a second USB OTG device which couple to each other through a USB cable, the first USB OTG being initially an A-host, and the second USB OTG device being initially a B-peripheral, the method comprising:
the second USB OTG device sending a first Host Negotiation Protocol (HNP) request to the first USB OTG device, wherein the HNP request is a request to become a host;
the first USB OTG device suspending the USB bus, resetting an OTG controller of the first USB OTG device, and modifying a state of an ID-pin detection end to a B-type from an A-type, and switching a role of the first USB OTG device to the B-peripheral from the A-host; and
after the second USB OTG detects that the first USB OTG device suspends the USB bus, the second USB OTG switching a role of the second USB OTG device to a B-host from the B-peripheral.

19. The method as claimed in claim 18 further comprising:
the second USB OTG device sending a second HNP request to the first USB OTG device, wherein the second HNP request is a request to return to a peripheral; and
the first USB OTG device resetting the OTG controller and modifying the state of the ID-pin detection end to the A-type from the B-type, and switching the role of the first USB OTG device to the A-host from the B-peripheral; and
the second USB OTG device switching a role of the second USB OTG device to the B-peripheral to the B-host.

20. The method as claimed in claim 18, wherein the first USB OTG device is a USB OTG device which supports an OTG 1.3 protocol, and the second USB OTG device is a USB OTG device which supports an OTG 2.0 protocol.

21. A system of switching a role of a Universal Serial Bus (USB) On-The-Go (OTG) device comprising:
a first USB OTG device; and
a second USB OTG device coupled to the first USB OTG device through a USB cable,
wherein the first USB OTG device comprises a first host controller, a first peripheral controller, and a first OTG controller, the first USB OTG is initially an A-host, the first OTG controller is coupled to the first host controller and the first peripheral controller, the first OTG controller comprises an ID-pin detection end which is used to detect a type of plug of a USB cable coupled to the first USB OTG device,
wherein the first OTG controller is configured to receive a first Host Negotiation Protocol (HNP) request sent from the second USB OTG device, suspend a USB bus, reset modify a state of an ID-pin detection end to a B-type from an A-type, and control a currently enabled controller of the first USB OTG device to switch to the first peripheral controller from the first host controller,
wherein the second USB OTG device comprises a second host controller, a second peripheral controller, and a second OTG controller, the second USB OTG is initially a B-peripheral, and
wherein the second OTG controller is configured to switch a role of the second USB OTG device to a B-host from the B-peripheral and control a currently enabled controller of the second USB OTG device to switch to the second host controller from the second peripheral controller after detecting the first USB OTG device suspend the USB bus.

22. The system as claimed in claim 21,
wherein the first OTG controller is further configured to receive a second HNP request from the second USB OTG device, reset, modify the state of the ID-pin detection end to the A-type from the B-type, and control the controller, which is currently enabled, to switch to the first host controller from the first peripheral controller, and
wherein the second OTG controller is further configured to switch the role of the second USB OTG device switches to the B-peripheral from the B-host, and control the controller, which is currently enabled, to switch to the second peripheral controller from second host controller after the second OTG controller sends a second HNP request to the first USB OTG device.

23. The system as claimed in claim 21, wherein the first USB OTG device is a USB OTG device which supports an OTG 1.3 protocol, and the second USB OTG device is a USB OTG device which supports an OTG 2.0 protocol.
